(19) United States
(12) Patent Application Publication
(10) Pub. No.: US 2007/0140646 A1
(43) Pub. Date: Jun. 21, 2007

(54) Non-linear editing device

(76) Inventor: Keiichi Sakano, Osaka (JP)

Correspondence Address: RATNERPRESTIA, P.O. BOX 980, VALLEY FORGE, PA, 19482, US

(21) Appl. No.: 10/583,111

(22) PCT Filed: Dec. 9, 2004
(86) PCT No.: PCT/JP04/18768

§ 371 Date: Jun. 14, 2006

(30) Foreign Application Priority Data
Dec. 18, 2003 (JP) 2003-420662

(51) Int. Cl. H04N 5/93

(52) U.S. Cl. 386/52

(57) ABSTRACT

A non-linear editing device capable of removing a medium from a system during editing or even after editing by copying a material file in the medium to another medium such as a built-in hard disk during editing and automatically changing a reference destination of material. This non-linear editing device includes a detachable first material storage part, a second material storage part, a material reference management part for managing a reference to the material file from a clip, and a material copying management part for allowing the material reference management part to execute the change of reference information.

### TECHNICAL FIELD

The present invention relates to a non-linear editing device for image, voice, and the like. In particular, it relates to copy processing of material files in the non-linear editing device.

### BACKGROUND ART

In conventional non-linear editing devices, a material such as image, voice, and the like is taken together with management information relating to the material from a medium such as a tape, which does not allow random access, into a random accessible medium such as a hard disk, and recorded as a file. On this random accessible medium, an index region for managing the recorded file is provided. By referring to this index region, it is possible to instantly grasp the recorded material and material management information. Such a conventional non-linear editing device is disclosed in, for example, Japanese Patent Unexamined Publication No. H9-161464.

Furthermore, recently, non-linear editing has been proposed, in which a random accessible medium such as a semiconductor memory card is used instead of a tape, and materials on the semiconductor memory card that is detachable from a non-linear editing device are used to be directly edited without taking materials into a hard disk. Hereinafter, such editing is referred to as direct editing.

### SUMMARY OF THE INVENTION

A non-linear editing device includes a random accessible and detachable first material storage part; a random accessible second material storage part; a material reference management part for managing a reference to a material file from a clip that is a direct operation object used by a user for accessing the material file stored in at least one of the first material storage part and the second material storage part; and a material copy management part for copying a copy original material file stored in the first material storage part to the second material storage part as a copy destination material file, and requesting the material reference management part to change reference information so as to allow a clip referring to the copy original material file to refer to the copy destination material file.

### BRIEF DESCRIPTION OF THE DRAWINGS

FIG. 1 is a diagram showing a configuration of a non-linear editing device in accordance with one exemplary embodiment of the present invention.

FIG. 2 is a diagram showing a configuration of a non-linear editing device in accordance with one exemplary embodiment of the present invention.

FIG. 3 is a diagram showing a configuration of a non-linear editing device in accordance with one exemplary embodiment of the present invention.

FIG. 4 is a view showing an operation image when a time line is being formed.

FIG. 5 is a view showing an operation image at the time of trimming.

FIG. 6 is a view showing a clip, a time line and a material reference region.

### DETAILED DESCRIPTION OF THE PREFERRED EMBODIMENTS

In direct editing, in the case where editing work is carried out by using a material file existing in a medium such as a semiconductor memory card, which is detachable from a system (hereinafter, such a medium is referred to as a removable medium), the removable medium naturally needs to be coupled to the system when reproduction of edited result and the like is considered. That is to say, it is considered that edited result is reproduced during editing work and even after editing work, it is impossible to remove the removable medium so as to be reused for other uses.

The present invention was made to solve the above-mentioned conventional problem, and it is an object of the present invention to copy a material file in a removable medium into another medium such as a built-in hard disk and separate the removable medium from a system during editing work or even after editing work, thereby enabling the removable medium to be reused in the other uses.

According to the present invention, during editing work, a material file in a removable medium is copied to another medium such as a built-in hard disk so as to change a reference destination of materials automatically. Thus, the removable medium can be separated from the system even after editing work or during editing work, and thereby an advantageous effect of enhancing the reusing property of the media can be obtained.

Hereinafter, exemplary embodiments of the present invention are described with reference to drawings.

### First Exemplary Embodiment

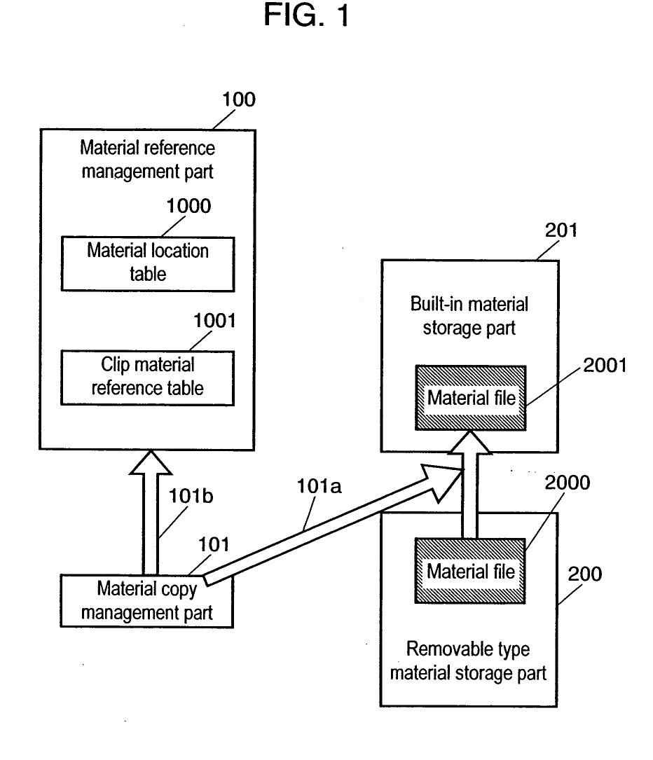

Firstly, an exemplary embodiment in which a material file is copied during editing work is described. FIG. 1 shows an outline of a non-linear editing device in accordance with this exemplary embodiment. The non-linear editing device includes material reference management part 100, material copy management part 101, removable type material storage part 200 and built-in material storage part 201. It is assumed that removable type material storage part 200 includes media such as a semiconductor memory card, an optical disk, and the like. This removable type material storage part 200 is an example of a random accessible and detachable first material storage part. Furthermore, it is assumed that built-in material storage part 201 includes a hard disk, and the like. This built-in material storage part 201 is an example of a random accessible second material storage part. Material reference management part 100 holds management information of material location table 1000 and clip material reference table 1001. Table 1 and Table 2 show an example of each table in accordance with this exemplary embodiment.

TABLE 1

| Material ID | Material location |
|---|---|
| Material ID 1 | P:¥VideoFolder¥Material1.avi |
| Material ID 2 | P:¥VideoFolder¥Material2.avi |
| . | . |
| . | . |
| . | . |

In removable type material storage part 200, copy original material file 2000 (hereinafter, referred to as material file 2000) is recorded. Then, with respect to each material file, material ID that is an identifier for uniquely specifying the material file is assigned. Material location table 1000 is a correspondence table between the material ID of the material file and the storage place (material location) thereof Table 1 shows that a material of material ID 1 is recorded under the file name of Material1.avi in a folder, VideoFolder of drive P that is removable type material storage part 200. Likewise, it is shown that a material of material ID 2 is recorded under the file name of Material2.avi in a folder, VideoFolder of drive P.

TABLE 2

| Clip ID | Material ID |
|---|---|
| Clip 1 | Material ID 1 |
| Clip 2 | Material ID 2 |
| . | . |
| . | . |
| . | . |

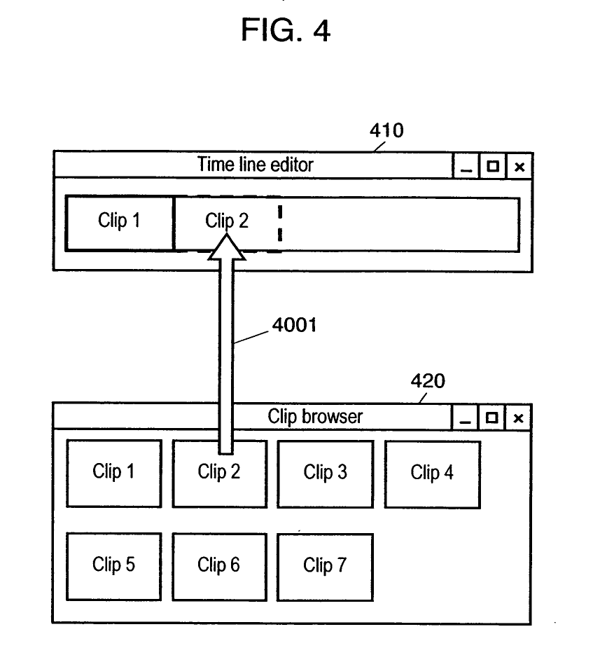

A clip is an abstract operation object used by a user for accessing a material file. Clips exist on a user interface (editing screen) of a non-linear editing device as shown in FIG. 4. A user carries out editing work by operating clips on the editing screen so as to form editing data (hereinafter, referred to as “time line”). Table 2 shows that an entity of clip 1 is a material represented by material ID 1, and that an entity of clip 2 is a material represented by material ID 2. Material reference management part 100 refers to these two tables, and thereby can search material files that are respective entities for clip IDs and access them.

Hereinafter, formation processing of management information of material location table 1000 and clip material reference table 1001, which is carried out prior to starting editing, is described. Material reference management part 100 lists up material files 2000 in removable type material storage part 200 and assigns respective material IDs with respect to the respective material files. Then, material reference management part 100 forms material location table 1000 as shown in Table 1. Furthermore, material reference management part 100 generates clips used by a user for accessing material files and generates clip material reference table 1001 as shown in Table 2. Furthermore, as mentioned below, a table may be generated at the side of a camera. When images are taken by photo equipment such as a camera, a camera material reference management part having a function that is equal to that of material reference management part 100 generates material files in removable type material storage part 200. At the same time, camera material reference management part assigns a material ID to the material file. Then, a camera material reference management part forms material location table 1000 as shown in Table 1. Furthermore, material reference management part 100 generates clips that can be used by a user for accessing the material file and generates clip material reference table 1001 as shown in Table 2.

Next, the copy processing of material files is described. Firstly, at an editing starting time etc., a user makes a request to copy this material file 2000 into built-in material storage part 201 in parallel with the editing work using material file 2000 existing in removable type material storage part 200. In accordance with this request, material copy management part 101 starts copy processing of all material files 2000 existing in removable type material storage part 200 into built-in material storage part 201. That is to say, material copy management part 101 issues copy processing command 101a so as to allow copy processing to be executed. This copy processing is carried out by using an empty resource (CPU, bus band, etc.) so as not to prevent the editing work.

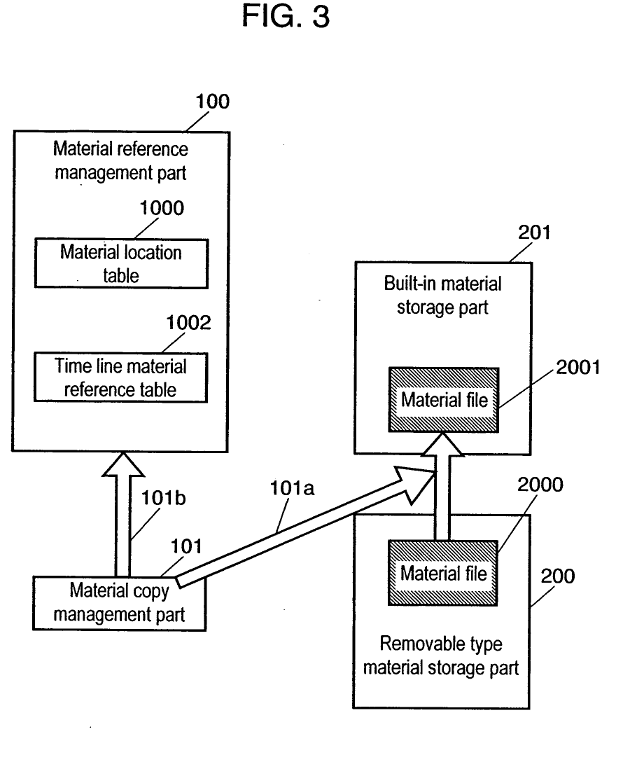

When copying is completed, a material file is increased by the copied part. Accordingly, material copy management part 101 requests material reference management part 100 to generate a new material ID. That is to say, material copy management part 101 issues material addition command 101b, so that a new material ID is generated. As a result, as shown in FIG. 3, a new material ID and a material location are added to material location table 1000. For example, a material file designated by material ID 1 is in P:¥VideoFolder¥Material1.avi in the removable medium. However, when this is copied to C:¥VideoFolder¥Material1.avi in C drive that is a built-in hard disk, new material ID 1′ is generated. The material location thereof is added to material location table 1000 as C:¥VideoFolder¥Material1.avi.

TABLE 3

| Material ID | Material location |
|---|---|
| Material ID 1 | P:¥VideoFolder¥Material1.avi |
| Material ID 2 | P:¥VideoFolder¥Material2.avi |
| . | . |
| . | . |
| . | . |
| Material ID 1′ | C:¥VideoFolder¥Material1.avi |
| Material ID 2′ | C:¥VideoFolder¥Material2.avi |
| . | . |
| . | . |
| . | . |

Subsequently, as shown in FIG. 4, material copy management part 101 requests material reference management part 100 to rewrite the material ID to which a clip refers to on clip material reference table 1001. That is to say, material copy management part 101 issues material adding command 101b and requests that materials ID should be rewritten. As a result, for example, the material ID to which clip 1 refers to is rewritten from material ID 1 to its copy, material ID 1′.

TABLE 4

| Clip ID | Material ID |
|---|---|
| Clip 1 | Material ID 1′ |
| Clip 2 | Material ID 2′ |
| . | . |
| . | . |
| . | . |

When rewriting is completed, reproduction of clips is carried out by using not material file 2000 designated by material ID 1, material ID 2 and the like in removable type material storage part 200 but copy destination material file 2001 (hereinafter, referred to as material file 2001) designated by material ID 1′ and material ID 2′ in built-in material storage part 201. Therefore, material file 2000 itself does not become necessary for editing work. That is to say, at this time, removable type material storage part 200 can be removed from a system. Furthermore, since copying of the material files is carried out in the background, a user can continue to carry out editing work without awareness of this. On the other hand, since rewriting of the clip IDs is also carried out in the background, a user can continue to carry out editing work without awareness of this. However, since the access speed is different between removable type material storage part 200 and built-in material storage part 201, the operation of the preview screen may be awkward. Therefore, the rewriting of the clip IDs may be carried out after allowing a user to confirm that rewriting may be carried out. Furthermore, before copying, a user may select whether rewriting is carried out automatically or rewriting is carried out after confirmation message is issued.

### Second Exemplary Embodiment

The first exemplary embodiment assumed the case where only clips exist in a system. However, in actual editing work, a time line is formed by arranging these clips. In this exemplary embodiment, copy processing of material files in a process for forming a time line is described.

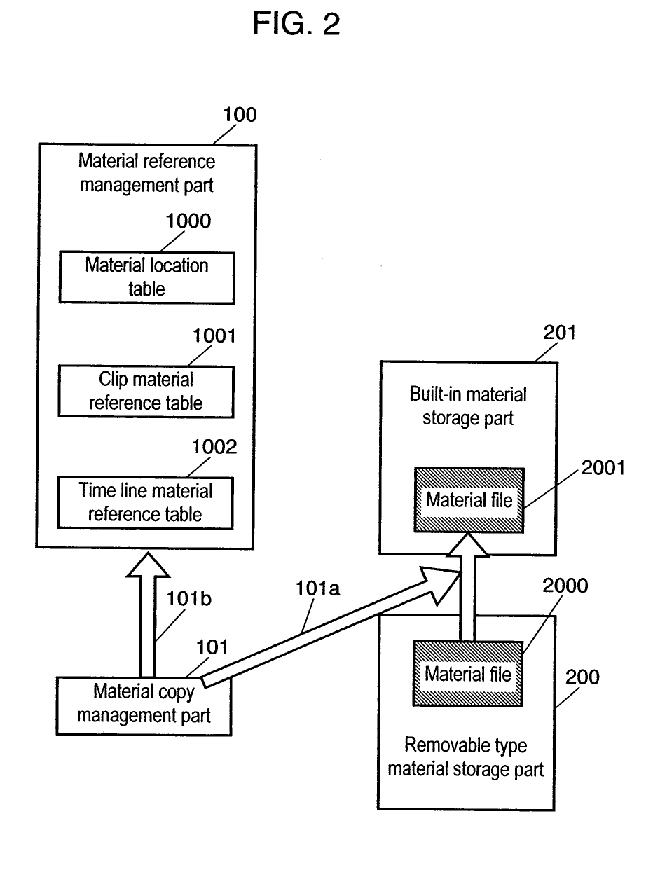

FIG. 2 shows a configuration of a non-linear editing device in accordance with this exemplary embodiment. The non-linear editing device of this exemplary embodiment is different from that of the first exemplary embodiment in that time line material reference table 1002 is newly provided in material reference management part 100.

FIG. 4 shows an image of the formation of a time line. As in the first exemplary embodiment, when material files are listed up and the corresponding clips are formed, as shown in the lower part of FIG. 4, the list of the clips are displayed (hereinafter, application therefor is referred to as clip browser 420). Next, a user performs drag and drop 4001 of desired clips in clip browser 420 on the application (hereinafter, referred to as time line editor 410) as shown in the upper part of FIG. 4 and arranges the clips. The thus formed arrangement of the clips is referred to as a time line. When the time line is formed, time line material reference table 1002 as shown in Table 5 is formed.

TABLE 5

| Time line ID | Component ID | Material ID |
|---|---|---|
| Time line 1 | Component 1 | Material ID 1 |
| | Component 2 | Material ID 2 |
| . | . | |
| . | . | |
| . | . | |

Herein, the component means each element constituting a time line. For example, in the case of the time line displayed in the upper part of FIG. 4, the element represented by clip 1 is component 1 and the element represented by clip 2 is component 2. Table 5 shows that two components, that is, component 1 and component 2 exist on time line 1 and the components refer to the material files represented by material ID 1 and material ID 2, respectively.

Note here that clip 1 make a reference to material ID 1 in Table 2, however, at the time clip 1 is dragged and dropped on time line 1, a reference to material ID 1 by component 1 newly occurs besides the above-mentioned reference.

Herein, processing for reproducing the time line is described. Herein, the case where time line 1 in Table 5 is reproduced is considered. In order to reproduce time line 1, firstly, it is necessary to reproduce component 1 located at the top. Table 5 shows that component 1 refers to material ID 1. Furthermore, Table 1 shows that material ID 1 is in P:¥VideoFolder¥Material1.avi. Similarly, it is shown that component 2 refers to material ID 2 and material ID 2 is in P:¥VideoFolder¥Material2.avi. From the mentioned above, it is shown that, for reproducing time line 1, P:¥VideoFolder¥Material1.avi may be firstly reproduced and P:¥VideoFolder¥Material2.avi may be then reproduced.

When the material file is copied, in the first exemplary embodiment, clip material reference table 1001 of Table 2 is changed. However, in this exemplary embodiment, in addition to this, it is necessary to also change time line material reference table 1002 in Table 5. When the case of the copy of material files similar to the first exemplary embodiment is considered, the time line material reference table in Table 5 is altered to that shown in Table 6 after copying is completed.

TABLE 6

| Time line ID | Component ID | Material ID |
|---|---|---|
| Time line 1 | Component 1 | Material ID 1′ |
| | Component 2 | Material ID 2′ |
| . | . | |
| . | . | |
| . | . | |

That is to say, when a material file represented by material ID 1 is copied, material ID 1′ corresponding to a copy destination material file is newly generated. In this case, not only clip 1 that referred to material ID 1 but also component 1 of time line 1 changes the material ID to be referred to from material ID 1 to material ID 1′. The same is true in material ID 2. Thus, material file 2000 itself is not needed when the time line is reproduced. That is to say, at this time, removable type material storage part 200 can be removed from the system.

### Third Exemplary Embodiment

In the second exemplary embodiment, besides clip material reference table 1001, time line material reference table 1002 is introduced. By the way, since it can be thought that a clip is a kind of a time line including one component, a clip material reference table can be integrated with a time line material reference table. FIG. 3 shows a configuration of a non-linear editing device in accordance with this exemplary embodiment and Table 7 shows time line material reference table 1002 at this time.

TABLE 7

| Time line ID | Component ID | Material ID |
|---|---|---|
| Time line 1 | Component 1 | Material ID 1 |
| | Component 2 | Material ID 2 |
| Time line 2 | Component 1 | Material ID 1 |
| (=clip 1) | | |
| Time line 3 | Component 1 | Material ID 2 |
| (=clip 2) | | |

In the second exemplary embodiment, after the copying of material files is completed, it is necessary to change two tables, that is, clip material file table 1001 and time line material reference table 1002. In this exemplary embodiment, only time line material reference table 1002 is changed. As a result, time line material reference table 1002 is altered from Table 7 to Table 8.

For example, when the material file represented by material ID 1 is copied, material ID 1′ corresponding to a copy destination material file is newly generated. In this case, component 1 of time line 1 and component 1 of time line 3, which referred to material ID 1, change the material ID to be referred to from material ID 1 to material ID 1′. The same is true in material ID 2.

TABLE 8

| Time line ID | Component ID | Material ID |
|---|---|---|
| Time line | Component 1 | Material ID 1′ |
| | Component 2 | Material ID 2′ |
| Time line 2 | Component 1 | Material ID 1′ |
| (=clip 1) | | |
| Time line 3 | Component 1 | Material ID 2′ |
| (=clip 2) | | |
| . | . | |
| . | . | |
| . | . | |

### Fourth Exemplary Embodiment

In the first, second and third exemplary embodiments, all of the material files in removable type material storage part 200 were copied. However, only a portion of the material files can be copied, if necessary. In this exemplary embodiment, the partial copying is described. Such a non-linear editing device can be shown by any of FIGS. 1 to 3 as in the first to third exemplary embodiments depending upon management tables to be held. Hereinafter, in this exemplary embodiment, as in the second exemplary embodiment, a configuration including material location table 1000, clip material reference table 1001 and time line material reference table 1002 is described. However, needless to say, this exemplary embodiment can be carried out with other configurations.

Note here that partial copying processing of this exemplary embodiment is described. As described in the second exemplary embodiment, a user performs drag and drop 4001 of clips in the clip browser so as to form a time line on time line editor 410. Material copy management part 101 recognizes by this drag and drop 4001 that clips are to be edited. Then, at this timing, material copy management part 101 checks the material ID referred to by the clips to be edited by using Table 2 or Table 5. Furthermore, material copy management part 101 checks a location of the material file of the material ID by using Table 1. Then, based on this, copying of this material file is started actually. That it to say, the material files to be copied are only the material files used by the clips which a user dragged and dropped 4001 from the clip browser to the time line editor.

When copying of the material files is completed, material reference management part 100 newly generates material ID. The location is added to material location table 1000 as shown in Table 3. Furthermore, with respect to the clip and the component in the time line which referred to the copy original material file, material ID to be referred to is changed to a new material ID after copying is completed. That is to say, clip material reference table 1001 is changed from that in Table 2 to that in Table 4, and time line material reference table 1002 is changed from that in Table 5 to that of Table 6. Note here that rewriting of clip material reference table 1001 and time line material reference table 1002 is executed after copying is completed.

Thus, not all the material files in the removable type material storage part are copied, but only material files that are actually used for editing are copied, thereby making it possible to save the copying time and volume of built-in material storage part 201 that is a destination of copy. Incidentally, in the case where the material file referred to by the clip which a user dragged and dropped 4001 on the time line editor has been already copied, it is not necessary to newly copy or change reference destinations. Furthermore, it may be thought that the material file was copied actually, however, the clip (component) which referred to this may be finally deleted from the time line. In this case, after editing work, the corresponding material files are deleted from the built-in material storage part that is a copy destination and at the same time, the register of the corresponding material ID is deleted from Table 3.

Herein, the material files started to be copied at the timing when a user drags and drops clips from the clip browser to the time line. However, a method can be thought in which a user is allowed to specifically designate the material files to be copied.

Note here that in this exemplary embodiment, only the material files to be edited are copied. The material files to be edited are copied preferentially and the other material files may be copied sequentially in an empty time.

### Fifth Exemplary Embodiment

In the above description, the case where with respect to clips or a time line, material ID of the material files which the clips and the time line refer to are managed is described. In this exemplary embodiment, in addition to the case, in the time line, a non-linear editing device that manages the range (reference range), that is, from which point (reference starting point) to which point (reference termination point) of the material file is described. In the non-linear editing device of this exemplary embodiment, material reference management part 100 further manages the reference starting point and the reference termination point in addition to the contents to be managed described above. That is to say, Tables 2, 5 and 7 in the first to fourth exemplary embodiments are changed to Tables 9, 10 and 11, respectively.

TABLE 9

| | | Reference starting | Reference |
|---|---|---|---|
| Clip ID | Material ID | point | termination point |
| Clip 1 | Material ID 1 | 0 | 100 |
| Clip 2 | Material ID 2 | 0 | 500 |
| . | . | | |
| . | . | | |
| . | . | | |

TABLE 10

| | | | Reference | |
|---|---|---|---|---|
| Time | | | starting | Reference |
| line ID | Component ID | Material ID | point | termination point |
| Time | Component 1 | Material ID 1 | 0 | 100 |
| line 1 | Component 2 | Material ID 2 | 0 | 500 |
| . | | . | | |
| . | | . | | |
| . | | . | | |

TABLE 11

| | | | Reference | Reference |
|---|---|---|---|---|
| | Component | | starting | termination |
| Time line ID | ID | Material ID | point | point |
| Time line 1 | Component 1 | Material ID 1 | 0 | 100 |
| | Component 2 | Material ID 2 | 0 | 500 |
| Time line 2 | Component 1 | Material ID 1 | 0 | 100 |
| (=clip 1) | | | | |
| Time line 23 | Component 1 | Material ID 2 | 0 | 500 |
| (=clip 2) | | | | |
| . | | . | | |
| . | | . | | |
| . | | . | | |

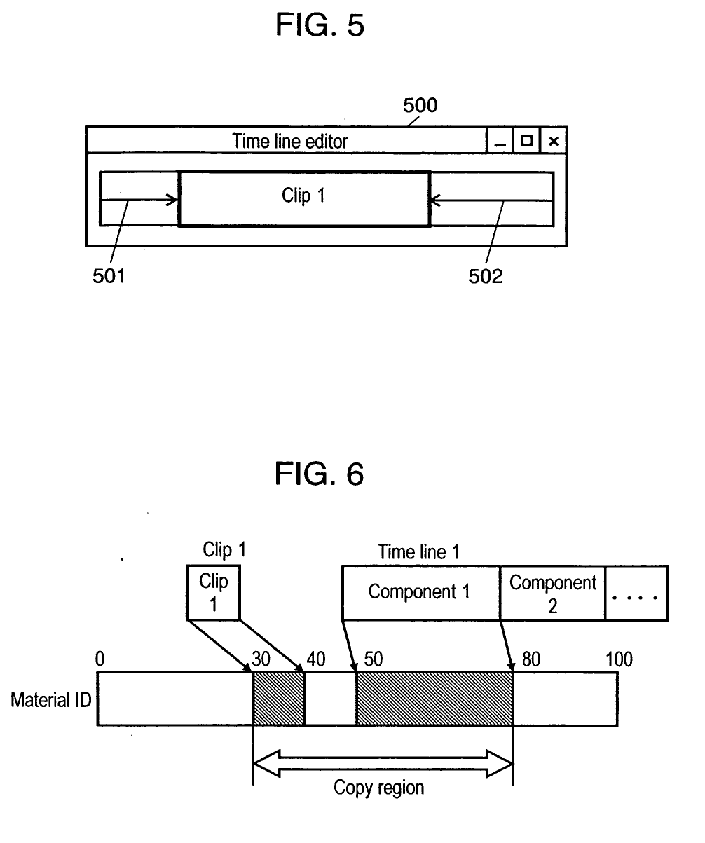

In this exemplary embodiment, by using these Tables, editing work by a user, in particular, working called trimming for changing the reference starting point and reference termination point of a clip is described. Firstly, trimming is carried out by adjusting the top position and the termination position of the clip by using an application (hereinafter, referred to as clip editor 500) shown in FIG. 5. That is to say, starting position shift 5001 of the clip and termination position shift 5002 of the clip are carried out. Material ID 1 includes images from the 0th frame through the 100th frame. When clip 1 is generated, initialization is carried out so that the reference starting point and the reference termination point indicate the 0th frame and the 100th frame which are the first frame and the last frame of material ID 1, respectively. Then, in clip editor 500, the reference starting point and the reference termination point of clip 1 are shifted as shown in FIG. 5. As a result, for example, Table 9 is altered to Table 12.

TABLE 12

| | | Reference starting | Reference |
|---|---|---|---|
| Clip ID | Material ID | point | termination point |
| Clip 1 | Material ID 1 | 30 | 40 |
| Clip 2 | Material ID 2 | 100 | 200 |
| . | . | | |
| . | . | | |
| . | . | | |

Specifically, clip 1 refers to the material file designated by material ID 1. However, the reference starting point thereof is changed from the 0th frame to the 30th frame and the reference termination point thereof is changed from the 100th frame to the 40th. Similarly, clip 2 refers to the material file designated by material ID 2. However, the reference starting point thereof is changed from 0th frame to the 100th frame and the reference termination point thereof is changed from the 500th frame to the 200th frame.

Furthermore, the trimming itself may be carried out with respect to the top position and the termination position of the component on time line editor 410 mentioned above. As a result, for example, Table 10 is altered to Table 13. Specifically, component 1 located at the top of time line 1 refers to material ID 1. However, the reference starting point thereof is changed from the 0th frame to the 50th frame and the reference termination point thereof is changed from the 100th frame to the 80th frame, respectively. Similarly, component 2 refers to material ID 2. However, the reference starting point thereof is changed from the 0th frame to the 20th frame and the reference termination point thereof is changed from the 500th frame to the 40th, respectively.

TABLE 13

| | | | | Reference |
|---|---|---|---|---|
| Time | | | Reference | termination |
| line ID | Component ID | Material ID | starting point | point |
| Time | Component 1 | Material ID 1 | 50 | 80 |
| line 1 | Component 2 | Material ID 2 | 20 | 40 |
| . | | . | | |
| . | | . | | |
| . | | . | | |

Similarly, in the case where Table 9 and Table 10 are integrated with each other and managed as shown in Table 11, as a result of trimming, the table is altered to Table 14.

TABLE 14

| | | | | Reference |
|---|---|---|---|---|
| Time | Component | | Reference | termination |
| line ID | ID | Material ID | starting point | point |
| Time | Component 1 | Material ID 1 | 50 | 80 |
| line 1 | Component 2 | Material ID 2 | 20 | 40 |
| Time | Component 1 | Material ID 1 | 30 | 40 |
| line 2 | | | | |
| (=clip 1) | | | | |
| Time | Component 1 | Material ID 2 | 100 | 200 |
| line 3 | | | | |
| (=clip 2) | | | | |
| . | | . | | |
| . | | . | | |
| . | | . | | |

When such a management is carried out, in the material file used for editing, only a reference region can be copied. Thus, compared with the fourth exemplary embodiment, the copying time and the volume of built-in material storage part 201 that is a copy destination can be further saved. For example, in the case of Table 12, clip 1 refers to the 30th frame through 40th frame from the top of the material file designated by material ID 1. Therefore, the copy by material copy management part 101 is carried out with respect to not entire material file designated by material ID 1 but a region including a section designated by the reference starting point and the reference termination point designated by editing. That is to say, only a region from the 30th frame through the 40th frame from the top of the material file is copied.

As a result, the material location table is altered to Table 3 similar to the above, while the clip material reference table is altered from Table 12 to Table 15. That is to say, it is necessary that not only the material ID referred to by the clip but also the reference starting point and the reference termination point are changed to those in the new material file and that the clip referring to the copy original material file is allowed to refer to the same section of the copy destination material files. For example, when material ID 1 is copied to built-in material storage part 201, eleven frames from the 30th frame through the 40th frame are copied. Therefore, copy destination material ID 1′ includes eleven frames from the 0th frame through the 10th frame. Then, as a result of change of the material ID, clip 1 comes to refer to the 0th frame through the 10th frame of the material files designated by material ID 1′.

TABLE 15

| | | Reference starting | Reference |
|---|---|---|---|
| Clip ID | Material ID | point | termination point |
| Clip 1 | Material ID 1′ | 0 | 10 |
| Clip 2 | Material ID 2′ | 0 | 100 |
| . | . | | |
| . | . | | |
| . | . | | |

Next, the case where not only the clip but also the time line is taken into account, that is, the case where material reference management part 100 has both clip material reference table 1001 and time line material reference table 1002 as shown in FIG. 2 is considered. For example, if clip material reference table 1001 and time line material reference table 1002 at this time are supposed to be respectively shown in Table 12 and Table 13, reference to the material file designated by material ID 1 from clip 1 and component 1 of time line 1 at this time is shown in FIG. 6, respectively. At this time, with respect to material ID 1, clip 1 refers to the 30th frame through the 40th frame, and furthermore, component 1 of time line 1 refers to the 50th frame through the 80th frame. In this case, in order to cover all the reference region, minimum range including two reference regions, that is, the 30th frame through the 80th frame is copied. Therefore, when the material ID corresponding to the material file that is formed as a result of copying is defined as material ID 1′, clip 1 refers to the 0th frame through the 10th frame from the top thereof Component 1 of time line 1 refers to the 20th frame through the 50th frame. Therefore, Table 12 is altered to Table 15 and meanwhile, Table 13 is altered to Table 16.

TABLE 16

| | | | | Reference |
|---|---|---|---|---|
| Time line | | | Reference | termination |
| ID | Component ID | Material ID | starting point | point |
| Time | Component 1 | Material ID 1′ | 20 | 50 |
| line 1 | Component 2 | Material ID 2′ | 0 | 20 |
| . | | . | | |
| . | | . | | |
| . | | . | | |

Similarly, when clip material reference table 1001 is integrated with time line material reference table 1002 and managed, Table 14 is altered to Table 17.

TABLE 17

| | | | | Reference |
|---|---|---|---|---|
| Time | Component | | Reference | termination |
| line ID | ID | Material ID | starting point | point |
| Time | Component 1 | Material ID 1′ | 20 | 50 |
| line 1 | Component 2 | Material ID 2′ | 0 | 20 |
| Time | Component 1 | Material ID 1′ | 0 | 10 |
| line 2 | | | | |
| (=clip 1) | | | | |
| Time | Component 1 | Material ID 2′ | 0 | 100 |
| line 3 | | | | |
| (=clip 2) | | | | |
| . | | . | | |
| . | | . | | |
| . | | . | | |

In the above, when a region to be copied is determined, a minimum range covering all of a plurality of the reference regions is copied. As a result, the 30th frame through the 80th frame of the material file designated by material ID 1 is copied. However, as the other implement, a region that is not actually used in the region determined above may not be copied, that is to say, the copy region may be divided into a plurality of regions. In other words, in the example mentioned above, since neither clip 1 nor component 1 of time line 1 refer to the 41st frame through the 49th frame, the copy region includes two places, that is, a place from the 30th frame through the 40th frame and a place from the 50th frame through the 80th frame.

In this case, since two material files are formed by copy processing, two material IDs need to be formed. When a material ID corresponding to the material file formed by copying the former part thereof is defined as material ID 1′ and a material ID corresponding to the material file copied from the latter part thereof is defined as material ID 1″, the material location table is changed to that shown in Table 18. Furthermore, at this time, clip material reference table (Table 12), time line material reference table (Table 13) and (Table 14) are changed to those shown in Tables 19, 20 and 21, respectively. Note here that the material ID referred to by component 1 of time line 1 becomes material ID 141 and the reference starting point becomes the 0th frame and the reference termination point becomes the 30th frame.

TABLE 18

| Material ID | Material location |
|---|---|
| Material ID 1 | P:¥VideoFolder¥Material1.avi |
| Material ID 2 | P:¥VideoFolder¥Material2.avi |
| . | . |
| . | . |
| . | . |
| Material ID 1′ | C:¥VideoFolder¥Material1-1.avi |
| Material ID 1″ | C:¥VideoFolder¥Material1-2.avi |
| Material ID 2′ | C:¥VideoFolder¥Material2.avi |
| . | . |
| . | . |
| . | . |

TABLE 19

| | | Reference starting | Reference |
|---|---|---|---|
| Clip ID | Material ID | point | termination point |
| Clip 1 | Material ID 1′ | 0 | 10 |
| Clip 2 | Material ID 2′ | 0 | 100 |
| . | . | | |
| . | . | | |
| . | . | | |

TABLE 20

| | | | | Reference |
|---|---|---|---|---|
| Time | Component | | Reference | termination |
| line ID | ID | Material ID | starting point | point |
| Time | Component 1 | Material ID 1″ | 0 | 30 |
| line 1 | Component 2 | Material ID 2″ | 0 | 20 |
| . | | . | | |
| . | | . | | |
| . | | . | | |

TABLE 21

| | | | Reference | Reference |
|---|---|---|---|---|
| | Component | | starting | termination |
| Time line ID | ID | Material ID | point | point |
| Time | Component 1 | Material ID 1″ | 0 | 30 |
| line 1 | Component 2 | Material ID 2′ | 0 | 20 |
| Time | Component 1 | Material ID 1′ | 0 | 10 |
| line 2 | | | | |
| (=clip 1) | | | | |
| Time | Component 1 | Material ID 2′ | 0 | 100 |
| line 3 | | | | |
| (=clip 2) | | | | |
| . | | . | | |
| . | | . | | |
| . | | . | | |

Note here that in the material file, only portions referred to by the clip and the component in the time line are copied. However, it is possible to copy a portion including some excess regions (margin) added to before and after the portion. Needless to say, in this case, the reference starting point and the reference termination point are is shifted backward by only a margin of the top portion of the file.

By the way, in this exemplary embodiment, the reference starting time point and the reference termination time point are designated by the frame number. The present invention is not limited to this configuration. The reference starting time point and the reference termination time point may be designated by a time code. The effect of the present invention can be obtained when they are designated by the time code.

### Sixth Exemplary Embodiment

In the above-mentioned exemplary embodiments, after copying of material files was completed, a material ID was newly formed and added to material location table 1000 of Table 1. Thereafter, clip material reference table 1001 and time line material reference table 1002 were rewritten. However, an implement is possible, in which with respect to the original material ID of material location table 1000, the material location is rewritten, and clip material reference table 1001 and time line material reference table 1002 are not rewritten. The material location table after copying of the material files is completed in this case is shown in Table 22.

TABLE 22

| Material ID | Material location |
|---|---|
| Material ID 1 | C:¥VideoFolder¥Material1.avi |
| Material ID 2 | C:¥VideoFolder¥Material2.avi |
| . | . |
| . | . |
| . | . |

### Seventh Exemplary Embodiment

In the above-mentioned exemplary embodiments, material reference management part 100 manages two tables, that is, clip material reference table 1001 and material location table 1000. However, these two tables are integrated with each other, and clip material reference table 1001 shown in Table 23 can directly manage the clip ID and the material location of the material file referred to by the clip ID. In this case, after the material files are copied, as shown in Table 24, the position of the material location of clip material reference table 1001 may be replaced.

TABLE 23

| Clip ID | Material location |
|---|---|
| Clip 1 | P:¥VideoFolder¥Material1.avi |
| Clip 2 | P:¥VideoFolder¥Material2.avi |
| . | . |
| . | . |
| . | . |

TABLE 24

| Clip ID | Material location |
|---|---|
| Clip 1 | C:¥VideoFolder¥Material1.avi |
| Clip 2 | C:¥VideoFolder¥Material2.avi |
| . | . |
| . | . |
| . | . |

Similarly, when material reference management part 100 manages two tables, that is, time line material reference table 1002 and material location table 1000, the two tables are integrated with each other and the time line material reference table as shown in Table 25 may directly manage each component in the time line and the material location of the material file referred to by the component. In this case, after the material files are copied, as shown in Table 26, the material location of the time line material reference table may be replaced.

TABLE 25

| Time line ID | Component ID | Material location |
|---|---|---|
| Time line 1 | Component 1 | P:¥VideoFolder¥Material1.avi |
| | Component 2 | P:¥VideoFolder¥Material2.avi |
| Time line 2 | Component 1 | P:¥VideoFolder¥Material1.avi |
| (=clip 1) | | |
| Time line 3 | Component 1 | P:¥VideoFolder¥Material2.avi |
| (=clip 2) | | |
| . | . | |
| . | . | |
| . | . | |

TABLE 26

| Time line ID | Component ID | Material location |
|---|---|---|
| Time line 1 | Component 1 | C:¥VideoFolder¥Material1.avi |
| | Component 2 | C:¥VideoFolder¥Material2.avi |
| Time line 2 | Component 1 | C:¥VideoFolder¥Material1.avi |
| (=clip 1) | | |
| Time line 3 | Component 1 | C:¥VideoFolder¥Material2.avi |
| (=clip 2) | | |
| . | . | |
| . | . | |
| . | . | |

By the way, in the description of the first to seventh exemplary embodiments, for simplifying the description, the case where the clip includes a simple file was described. However, actually, in many cases, the clip includes not a simple file but a plurality of files. That is to say, in general, in many cases, one clip includes one video and several audios. The present invention can be applied not only to such a simple file but also a plurality of files. Hereinafter, such a case is described.

For example, a clip including one video and several audios is called an AV clip. Then, in the time line shown in FIGS. 4 and 5, a plurality of components are arranged in the direction of the lateral axis (time axis). A plurality of AV clips are arranged in the direction of the longitudinal axis (track conception).

In the description of the first to seventh exemplary embodiments, for simplifying the description, the case where the file is named by XXX.avi and video and audio are configured in one file is described. However, in general, an AV clip has different files for each channel of the video and audio or may be common file format. In the case where the file format is different between video and audio, the format of the video is, for example, “ClipA.avi,” the format of the first channel audio is, for example, “ClipA01.wav,” and the format of the second channel audio is, for example, “ClipA02.wav.” On the other hand, when video and audio have a common file format, the format of the video is, for example, “ClipA.mxf,” and the format of the first channel audio is, for example, “ClipA01.mxf,” and the format of the second channel audio is, for example, “ClipA02.mxf.” Therefore, the file names in Tables, 1, 3 and 18 and 22 to 26 are mentioned above, respectively. Furthermore, in Tables 2, 4, 9, 12, 15 19, 23, and 24, only one file is described with respect to only one clip. However, when the clip is configured by a plurality of files, in these tables, one clip includes a plurality of files.

Next, the rewriting timing of each table in the case where the time line and AV clip include a plurality of files is described. This rewriting has some methods. An example of the method includes a method of rewriting in a file unit. In this method, every time copying of one file is completed, only items related to this file are rewritten. Furthermore, an example of the method includes a batch rewriting method, that is, a method of rewriting all the clips at one time when copying of all the files of one clip is completed. Furthermore, an example of the other method of batch rewriting includes a method of rewriting at the timing when copying of all the files of the clip is completed. In these two batch rewriting methods, difference occurs when a plurality of clips are copied.

By the way, in the description of the first to seventh exemplary embodiments, for simplilying the description, an example in which the file format handled in removable type material storage part 200 and the file formats handled in the other parts are entirely the same is described. However, actually, during the process of non-linear editing processing, the file format may be once changed. The present invention can be applied to the case where the file format is once changed. In such a non-linear editing device, when reproduction is carried out, a path of the material file is managed in some manner. Then, when the material file is copied to the other medium, change of paths of the material files always occurs.

Note here that in the first to seventh exemplary embodiments, copy destination of the material file is to be built-in material storage part 201 such as a hard disk. However, this may be a network type material storage part such as a server and a drive of the other machine or a removable type material storage part such as a semiconductor memory card, an optical disk, or the like, which is different from that of copy origin. In this case, the same effect can be obtained.

### INDUSTRIAL APPLICABILITY

The present invention can be used for a non-linear editing device for image, voice, and the like, in which a removable medium can be separated from a system during editing work or even after editing work, and reused in the other applications.

1. A non-linear editing device, comprising:
a random accessible and detachable first material storage part;
a random accessible second material storage part;
a material reference management part for managing a reference to a material file from a clip that is a direct operation object used by a user for accessing the material file stored in at least one of the first material storage part and the second material storage part; and
a material copy management part for copying a copy original material file stored in the first material storage part to the second material storage part as a copy destination material file, and requesting the material reference management part to change reference information so as to allow a clip referring to the copy original material file to refer to the copy destination material file.

2. The non-linear editing device of claim 1,
wherein the material reference management part includes:
a material location table expressing a corresponding relation between a material ID for uniquely identifying the material file and a material location specifying a storage place of the material file; and
a clip material reference table expressing a corresponding relation between the clip and a material ID to which the clip refers.

3. The non-linear editing device of claim 1,
wherein the material reference management part includes:
a material location table expressing a corresponding relation between a material ID for uniquely identifying the material file and a material location specifying a storage place of the material file;
a clip material reference table expressing a corresponding relation between the clip and the material ID to which the clip refers; and
a time line material reference table expressing a corresponding relation between a component that is an element constituting a time line formed as a result of editing carried out by arranging one or more of the clips and a material ID to which the component refers.

4. The non-linear editing device of claim 1,
wherein the material reference management part includes:
a material location table expressing a corresponding relation between a material ID for uniquely identifying the material file and a material location specifying a storage place of the material file; and
a time line material reference table expressing a corresponding relation between a component that is an element constituting a time line formed as a result of editing carried out by arranging one or more of the clips and a material ID to which the component refers.

5. The non-linear editing device of claim 1, wherein the material reference management part includes a clip material reference table expressing a corresponding relation between the clip and a material location specifying a storage place of the material file to which the clip refers.

6. The non-linear editing device of claim 1, wherein the material reference management part includes a time line material reference table expressing a corresponding relation between a component that is an element constituting a time line formed as a result of editing carried out by arranging one or more of the clips and a material location specifying a storage place of the material file to which the component refers.

7. The non-linear editing device of claim 1, wherein the material copy management part copies at least a material file that is to be edited among the copy original material files stored in the first material storage part to the second material storage part as the copy destination material file.

8. The non-linear editing device of claim 1,
wherein the material reference management part manages a reference starting point and a reference termination point of the material file to which the clip refers to; and
the material copy management part copies a region including a section designated by the reference starting point and the reference termination point designated by editing in the copy original material file stored in the first material storage part to the second material storage part as the copy destination material file, and requests the material reference management part to change reference information so as to allow the clip referring to the copy original material file to refer to the same section of the copy destination material file.
